(19) United States
(12) Patent Application Publication
(10) Pub. No.: US 2014/0278637 A1
(43) Pub. Date: Sep. 18, 2014

(54) MONITORING RECURRING ACTIVITIES

(71) Applicant: UNITED PARCEL SERVICE OF AMERICA, INC., ATLANTA, GA (US)

(72) Inventor: MARK J. DAVIDSON, ALPHARETTA, GA (US)

(73) Assignee: UNITED PARCEL SERVICE OF AMERICA, INC., ATLANTA, GA (US)

(21) Appl. No.: 13/795,568

(22) Filed: Mar. 12, 2013

(51) Int. Cl. G06Q 10/06

(52) U.S. Cl. CPC G06Q 10/063114
USPC 705/7.15

(57) ABSTRACT

Computer program products, methods, systems, apparatus, and computing entities are provided for monitoring recurring activities. In one embodiment, activity data and work data can be analyzed to identify segments of inactivity during work segments. The inactivity segments can then be provided for an interface for display.

### BACKGROUND

Various business entities have workers that performed recurring activities. Thus, a need exists for monitoring the efficiency of such workers with regard to performance metrics and/or each other.

### BRIEF SUMMARY

In general, embodiments of the present invention provide methods, apparatus, systems, computing devices, computing entities, and/or the like for monitoring recurring activities.

In accordance with one aspect, a method for monitoring recurring activities is provided. In one embodiment, the method comprises (1) receiving activity data corresponding to a worker and a work period in which the worker performed one or more recurring activities; and (2) identifying one or more inactivity segments during the work period that meet a configurable threshold based at least in part on the activity data, the one or more inactivity segments representing a time period for which the worker did not perform recurring activities during the work period.

In accordance with another aspect, a computer program product for monitoring recurring activities is provided. The computer program product may comprise at least one computer-readable storage medium having computer-readable program code portions stored therein, the computer-readable program code portions comprising executable portions configured to (1) receive activity data corresponding to a worker and a work period in which the worker performed one or more recurring activities; and (2) identify one or more inactivity segments during the work period that meet a configurable threshold based at least in part on the activity data, the one or more inactivity segments representing a time period for which the worker did not perform recurring activities during the work period.

In accordance with yet another aspect, an apparatus comprising at least one processor and at least one memory including computer program code is provided. In one embodiment, the at least one memory and the computer program code may be configured to, with the processor, cause the apparatus to (1) receive activity data corresponding to a worker and a work period in which the worker performed one or more recurring activities; and (2) identify one or more inactivity segments during the work period that meet a configurable threshold based at least in part on the activity data, the one or more inactivity segments representing a time period for which the worker did not perform recurring activities during the work period.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a computing entity according to one embodiment of the present invention.

FIG. 3 is an exemplary schematic diagram of a user computing entity according to one embodiment of the present invention.

FIG. 4 is a flowchart illustrating operations and processes that can be used in accordance with various embodiments of the present invention.

FIGS. 5-12 show exemplary input and output that can be produced in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing devices, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. EXEMPLARY SYSTEM ARCHITECTURE

FIG. 1 provides an illustration of an exemplary embodiment of the present invention. As shown in FIG. 1, this particular embodiment may include one or more monitoring computing entities 100, one or more user computing entities 105, and one or more networks 120. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Monitoring Computing Entity

FIG. 2 provides a schematic of a monitoring computing entity 100 according to one embodiment of the present invention. In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the monitoring computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the monitoring computing entity 100 may communicate with user computing entities 105 to monitor recurring activities.

As shown in FIG. 2, in one embodiment, the monitoring computing entity 100 may include or be in communication with one or more processing elements 205 (also referred to as processors, processing circuitry, and/or similar terms used herein interchangeably) that communicate with other elements within the monitoring computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the monitoring computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include a monitoring program that analyzes recurring activities, for example. The term database, database instance, database management system, and/or similar terms used herein interchangeably may refer to a structured collection of records or data that is stored in a computer-readable storage medium, such as via a relational database, hierarchical database, and/or networker database.

In one embodiment, the monitoring computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the monitoring computing entity 100 with the assistance of the processing element 205 and operating system.

As indicated, in one embodiment, the monitoring computing entity 100 may also include one or more communications interfaces 220 for communicating with or various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the monitoring computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the monitoring computing entity 100 may include or be in communication with one or more input elements, such as a keyboard input, a mouse input, a touch screen/display input, audio input, pointing device input, joystick input, keypad input, and/or the like. The monitoring computing entity 100 may also include or be in communication with one or more output elements (not shown), such as audio output, video output, screen/display output, motion output, movement output, and/or the like.

As will be appreciated, one or more of the computing entity's 100 components may be located remotely from other monitoring computing entity 100 components, such as in a distributed system. Furthermore, one or more of the components may be combined and additional components performing functions described herein may be included in the monitoring computing entity 100. Thus, the monitoring computing entity 100 can be adapted to accommodate a variety of needs and circumstances.

### 2. Exemplary User Computing Entity

A user may be an individual, a family, a company, an organization, an entity, a department within an organization, a representative of an organization and/or person, and/or the like. FIG. 3 provides an illustrative schematic representative of a user computing entity 105 that can be used in conjunction with embodiments of the present invention. In general, the terms device, system, computing entity, entity, and/or similar words used herein interchangeably may refer to, for example, one or more computers, computing entities, computing entities, mobile phones, desktops, tablets, notebooks, laptops, distributed systems, watches, glasses, key fobs, radio frequency identification (RFID) tags, ear pieces, scanners, cameras, wristbands, kiosks, input terminals, servers, blades, gateways, switches, processing devices, processing entities, relays, routers, network access points, base stations, the like, and/or any combination of devices or entities adapted to perform the functions, operations, and/or processes described herein. The user computing entities 105 can belong to, be assigned to, or be associated with one or more workers. Or, there may be user computing entities throughout an establishment or facility for shared use. As shown in FIG. 3, the user computing entity 105 can include an antenna 312, a transmitter 304 (e.g., radio), a receiver 306 (e.g., radio), and a processing element 308 (such as those described above with regard to the monitoring computing entity 100) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 105 may be capable of operating with one or more air interface standards, communication protocols, modulation types, and access types. More particularly, the user computing entity 105 may operate in accordance with any of a number of wireless communication standards and protocols, such as those described above with regard to the monitoring computing entity 100. In a particular embodiment, the user computing entity 105 may operate in accordance with multiple wireless communication standards and protocols, such as UMTS, CDMA2000, 1xRTT, WCDMA, TD-SCDMA, LTE, E-UTRAN, EVDO, HSPA, HSDPA, Wi-Fi, WiMAX, UWB, IR, Bluetooth, USB, and/or the like.

Via these communication standards and protocols, the user computing entity 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 105 can also download changes, add-ons, and updates, for instance, to its firmware, software (e.g., including executable instructions, applications, program modules), and operating system.

According to one embodiment, the user computing entity 105 may include a location determining device and/or functionality. For example, the user computing entity 105 may include a Global Positioning System (GPS) module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The user computing entity 105 may also comprise a user interface (that can include a display 316 coupled to a processing element 308) and/or a user input interface (coupled to a processing element 308). The user input interface can comprise any of a number of devices allowing the user computing entity 105 to receive data, such as a keypad 318 (hard or soft), a touch display, voice or motion interfaces, or other input device. In embodiments including a keypad 318, the keypad 318 can include (or cause display of) the conventional numeric (0-9) and related keys (#, *), and other keys used for operating the user computing entity 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 105 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 105.

### III. EXEMPLARY SYSTEM OPERATION

Reference will now be made to FIGS. 4-12. FIG. 4 is a flowchart illustrating operations and processes that can be used in accordance with various embodiments of the present invention. FIGS. 5-12 show exemplary input and output that can be produced in accordance with various embodiments of the present invention.

### 1. Recurring Activities

Various embodiments of the present invention can be used to monitor recurring activities of one or more workers, of one or more groups of workers, of one or more employees, of one or more groups of employees, at one or more locations, at one or more groups of locations, at one or more facilities, at one or more groups of facilities, and/or of or at combinations thereof.

As will be recognized, a “recurring” activity may be an activity that is performed periodically, regularly, occasionally, continuously, and/or the like. For example, such activities may include a package loader/unloader for a shipping carrier loading packages into or unloading packages from a container, vehicle, or conveyor belt. Such activities may also include a stockperson stocking shelves in a grocery store, restocking medications in medication cabinets/carts, or stocking inventory in a warehouse. In yet further examples, such reoccurring activities may include checking out customers at a full-service checkout, self-service checkout, or kiosk; scanning or ringing up items as part of a checkout process; packing or bagging items that have been purchased; gift wrapping items that have been purchased; delivering items to customers in-store that were ordered online; washing vehicles; parking vehicles through a valet stand; and/or the like.

In yet other examples, such recurring activities may include assembly line activities, such as attaching items to products; quality monitoring activities, such as ensuring that items or products are within quality standards; order processing, such as pick-and-pack operations monitoring how many orders are processed or how many items are picked and packed; and/or the like. Such activities may also include collecting tolls from patrons of toll roads; embarking or disembarking passengers on airplanes or cruise ships; loading or unloading patrons on rides at amusement parks; and/or the like. Such activities may also include food preparation or serving: preparing or serving entrées, appetizers, desserts, or salads; serving patrons in a cafeteria or other first-in-first-out line; preparing items for use by a particular shift; and/or the like. As will be recognized, embodiments of the present invention can be used with any of a variety activities to adapt to various needs and circumstances.

In one embodiment, to monitor such recurring activities, the monitoring system 100 may create, update, store, and/or have access to worker profiles that correspond to workers who perform, monitor, analyze, and/or supervise such recurring activities. Such worker profiles can be created, edited, and/or customized to adapt to various needs and circumstances. For example, a worker profile may include a worker's employee identification number, name, email addresses, short message service (SMS) addresses, phone numbers, and/or residential address. In addition to biographical information, a worker profile may also comprise a worker's/user's primary skill, work/job class, home team of workers (e.g., the worker's department), full-time equivalent value, base rate of pay, hire date, termination date, and/or seniority date. Similarly, a worker profile may also comprise the worker's emergency contact information, birthday, languages spoken, driving distance to work, and/or ethnicity. Other information could also be stored within a worker profile, such as the worker's certifications or licenses, experience, schedule preferences, religious holidays observed, allergies, and/or physical limitations.

In one embodiment, each worker profile can also be associated with or assigned to one or more worker groups. The worker groups can be used to, for example, group workers who have similar primary skills, work at the same facility, work in the same department within a facility, work on the same team of workers, have similar experience, hold certain certifications, and/or report to a common supervisor. For example, a worker group may comprise all package loaders/unloaders for a shipping carrier or all chefs for a restaurant or restaurant chain. As will be recognized, though, a variety of other approaches and techniques may be used to adapt to various needs and circumstances.

### 2. Activity Data and Worker Data

In one embodiment, the process may begin with a worker providing input, an indication, or similar words used herein interchangeably that he or she is beginning work. For example, beginning work may be the start of a shift in the morning on a Monday. To provide such an indication, the worker may input some form of the indication via a user computing entity 105. As previously described, a user computing entity 105 may be any of a variety of computing entities that can perform the functions described herein. For instance, to input an indication the he or she is beginning work, the worker may navigate to an application on a mobile device and select an appropriate option. Similarly, the worker may log in to a touch screen kiosk, scan a barcode attached to an employee ID, or depress a specific button on a watch. Even further, such an indication may be provided via audible input through Bluetooth ear piece, selected or input using a mouse or keyboard on a laptop or computer, punched in using a manual timecard or recorded via an electronic time card. Or, such an indication may be provided by turning on glasses worn by the worker, scanning a key fob, scanning using a scanner, taking an image with a camera, or scanning an RFID tag.

Continuing with the above examples of a package loader/unloader for a shipping carrier, the package loader/unloader for the shipping carrier may scan a barcode worn on his person. Similarly, a restaurant chef or cook may prepare food near a touch screen through which he or she can login for work. As will be recognized, a variety of other approaches and techniques can be used to adapt to various needs and circumstances.

The indication that the user is beginning work can be provided by the user computing entity 105 to the monitoring computing entity 100 on a periodic, regular, or continuous basis or in response to certain triggers. The monitoring computing entity 100 can then create, update, revise, and store records of worker data associated with the workers and their work periods. Such records may be used for monitoring employees, reviewing work history, payroll, and/or a variety of other items.

In one embodiment, each time a worker performs a recurring activity, the user computing entity 105 records some form of input (activity data). For example, each time a package loader/unloader for a shipping carrier loads a package into or unloads a package from a container, vehicle, or conveyor belt, the package loader/unloader may scan a label affixed to the exterior of the package to record a location or movement activity for the package. In that regard, the user computing entity 105 may provide this information to the monitoring computing entity 100, which can create, update, and/or store a record of activity data for the same. An exemplary activity data record representing such an activity is provided in FIG. 5. As can be seen from FIG. 5, the package that was unloaded or loaded has a unique tracking number of 1Z123456789. The record in FIG. 5 also includes information regarding the activity performed by the package loader/unloader. For instance, the package was loaded or unloaded at the Roswell Facility (Roswell 12R) located in Roswell, Ga. Further, the package was loaded into or unloaded from Trailer 8ZR13547GF at 11:20:35 on Nov. 11, 2013, by package loader/unloader E8675309. Another exemplary activity data record representing a recurring activity is provided in FIG. 6. As can be seen from FIG. 6, the package that was unloaded or loaded has a unique tracking number of 1Z987654321. The record in FIG. 6 also includes information regarding the scan performed by the package loader/unloader. For instance, the package was loaded or unloaded at the Roswell Facility (Roswell 12R) located in Roswell, Ga. Further, the package was loaded into or unloaded from Trailer 8ZR13547GF at 11:20:47 on Nov. 11, 2013, by package loader/unloader E8675309.

In one embodiment, such records may be created, updated, and/or stored to include information regarding the various activities. For instance, each time a restaurant chef or cook completes an order (e.g., based on the order number and corresponding information being displayed to the chef or cook via a display), he or she may input via a touch screen that the order is complete and ready to be served to the customer. Exemplary records representing such activities are provided in FIGS. 7 and 8. As can be seen from FIG. 7, order number 1634 was input by Server 128 on Nov. 9, 2013, at 17:20:00. The order included two entrées (Baked Chicken and Seared Halibut) and two sides (Fresh Greens and Creamed Corn). Chef or Cook 593 completed order 1634 at 17:37:01. Similarly, as can be seen from FIG. 8, order number 1642 was input by Server 993 on Nov. 9, 2013, at 17:26:17. The order included one entrée (Flank Steak) and one side (Mashed Potatoes). Chef or Cook 593 completed order 1642 at 17:59:46.

As noted, each time a worker completes a recurring activity, a user computing entity 105 can receive some form or input such that a corresponding record can be created, updated, and/or stored. Such input may be received from a worker scanning an item or barcode, depressing a specific button on a watch, providing audible input through Bluetooth ear piece, selecting or inputting information using a mouse or keyboard on a laptop or computer, providing input via glasses worn by the worker, scanning a key fob, providing input via touch screen, scanning an RFID tag, and/or the like. The user computing entity 105 can provide such activity data to the monitoring computing entity 100 on a periodic, regular, or continuous basis or in response to certain triggers. The monitoring computing entity 100 can then create, update, revise, and store records of activity data.

In one embodiment, using similar approaches, workers can provide input via a user computing entity 105 each time they start a break and end a break (worker data). The input may specify, for example, the type of break, such as lunch break, smoking break, restroom break, and/or the like. Workers can also input a variety of other information, such as when they are performing non-recurring activities at the request of a coworker or supervisor, such as cleaning a work area or repairing work equipment. They may also input information as to why they are not performing recurring activities (worker data), such as no packages to load or unload and/or no food items to prepare. And workers can also provide input or indication when they are stopping work for a work period (worker data), such as shift ending as described above with beginning work. The user computing entity 105 can provide such worker data to the monitoring computing entity 100 on a periodic, regular, or continuous basis or in response to certain triggers. The monitoring computing entity 100 can then create, update, revise, and store records of worker data. Such information (worker data) may be stored in one or more records corresponding to a worker, worker group, work period, and/or the like.

FIGS. 9 and 10 show records comprising worker data for a package loader/unloader and a chef, respectively. As can be seen in FIG. 9, package loader/unloader E8675309 worked from 12:00:00-18:03:46 on Nov. 9, 2013. During this work period, package loader/unloader E8675309 took a lunch break from 14:09:46-14:40:23. Package loader/unloader E8675309 also input that he or she had a period of inactivity from 15:13:17-15:33:46 that corresponds to reason code 11. Reason code 11 may be a particular reason code defined by the carrier, for example. As can be seen in FIG. 10, chef C593 worked from 14:00:00-23:19:11 on Nov. 9, 2013. During this work period, chef C593 took three breaks: (1) Break 1 from 15:39:46-15:50:23; (2) Break 2 from 17:11:43-17:39:56; and (3) Break 3 from 21:42:46-22:07:35. The worker data and the activity data can be used to determine a variety of information about the work habits, performance, productivity, planning, efficiency, and/or the like of employees, plans, organizations, facilities, and/or the like. As will be recognized, a variety of other approaches and techniques can be used to adapt to various needs and circumstance.

### 3. Analysis/Segmentation of Work Data and Activity Data

In one embodiment, the monitoring computing entity 100 can analyze/segment activity data and/or worker data corresponding to one or more work time periods separately and/or in relation to one another. The work time periods may be input by a user (e.g., a supervisor reviewing the performance of loaders/unloaders or a restaurant owner or manager reviewing the productivity of chefs or servers). With the relevant work time periods identified, the monitoring computing entity 100 can identify/determine segments of inactivity that exceed one or more configurable thresholds that may represent unproductive performance by one or more workers. Continuing with the above example, the monitoring computing entity 100 can receive input via a user computing entity 105 indicating that the particular time period of interest is Nov. 9, 2013, for both the shipping carrier and restaurant.

The monitoring computing entity 100 may then request, retrieve, or otherwise obtain access to the relevant records. For example, in the shipping carrier context, the monitoring computing entity 100 may request, retrieve, or otherwise obtain access to the records with the relevant activity data, such as the records for all packages that package loader/unloader E8675309 loaded or unloaded on Nov. 9, 2013 (FIGS. 5 and 6). Additionally, the monitoring computing entity 100 may also request, retrieve, or otherwise obtain access to the records with the relevant work data, such as the record for package loader/unloader E8675309 dated Nov. 9, 2013 (FIG. 9). In the restaurant context, the monitoring computing entity 100 may request, retrieve, or otherwise obtain access to the records with the relevant activity data, such as the records for all orders entered and completed at a particular location on Nov. 9, 2013 (FIGS. 7 and 8). Additionally, the monitoring computing entity 100 may also request, retrieve, or otherwise obtain access to the records with the relevant work data, such as the record for chef C593 dated Nov. 9, 2013 (FIG. 10). With such records, the monitoring computing entity 100 can analyze the activity data and/or the worker data corresponding to one or more work time periods separately and/or in relation to one another.

In one embodiment, a work period for worker may be divided into a start-of-work segment, a work segment, and an end-of-work segment. In one embodiment, the monitoring computing entity 100 can associate or identify these segments according to the following logic. The start-of-work segment may be associated or identified by the monitoring computing entity 100 from the start time in the work data from the worker's corresponding record for the work period (e.g., for Nov. 9, 2013) indicating that he or she began working (e.g., from the work data) followed by the first recurring activity being recorded in the activity data for the work period (e.g., scanning a first package or completing a first order for the work period from the activity data). The work segment may be associated or identified by the monitoring computing entity 100 from the first recurring activity being recorded in the activity data for the work period (e.g., scanning a first package or completing a first order for the work period from the activity data) to the last recurring activity being recorded in the activity data for the work period (e.g., scanning a last package or completing a last order for the work period from the activity data). Similarly, the end-of-work segment may be associated or identified by the monitoring computing entity 100 from the last recurring activity being recorded in the activity data for the work period (e.g., scanning a last package or completing a last order for the work period from the activity data) followed by the end time in the work data from the worker's corresponding record for the work period (e.g., for Nov. 9, 2013) indicating that he or she stopped working (e.g., from the work data).

In one embodiment, the monitoring computing entity 100 can then determine whether there are any segments of inactivity during the work segment that meet or exceed one or more configurable thresholds. The configurable thresholds may be 30 seconds, 180 seconds, 5 minutes, 15 minutes, and/or any other time period to adapt to various needs and circumstances. In the shipping carrier example, for instance, the monitoring computing entity 100 may determine whether there are any segments of inactivity that meet or exceed 180 seconds. In one embodiment, this may be because packages can be loaded and unloaded at a high rate, and an inactivity segment of 180 seconds or more may indicate that the loader is not performing at capacity. In the restaurant carrier, though, the monitoring computing entity 100 may determine whether there are any segments of inactivity that meet or exceed 15 minutes. In one embodiment, this may be because preparing entrées for a table may take a considerably more time than placing packages on a conveyor or into a container. Thus, the configurable threshold may be much greater in the restaurant context.

As mentioned, such configurable thresholds can be configured by a user (e.g., a supervisor reviewing the performance of loaders/unloaders or a restaurant owner or manager reviewing the productivity of chefs or servers). For instance, a user may specify or adjust the configurable thresholds before, during, and/or after the analysis. Thus, when the user wants to identify short segments of inactivity, such as 20 seconds, the user can provide such input via the user computing entity 105 that is passed to the monitoring computing entity 100. In another embodiment, where a user wants to identify only long segments of inactivity, such as 5 minutes, the user can provide such input via the user computing entity 105 that is passed to the monitoring computing entity 100. With the configurable thresholds, the monitoring computing entity 105 can compare the duration of each segment of inactivity to the relevant configurable thresholds and identify all segments of inactivity meeting or exceeding the threshold during the work segment.

Continuing with the above examples, in the shipping context, the monitoring computing entity 100 can analyze the scan times of each package scanned by package loader/unloader E8675309 during the work segment or work period in a sequential manner. For instance, package loader/unloader E8675309 scanned package 1Z123456789 at 11:20:35 and package 1Z987654321 at 11:20:47. Thus, there is a gap in time of 12 seconds between scanning package 1Z123456789 and scanning package 1Z987654321. Any gaps between the sequentially-ordered scan times that meet or exceed the one or more configurable thresholds can be identified as segments of inactivity. The monitoring computing entity 100 can perform such analyses for all activities during the work period and/or work segment.

Further continuing with the above examples, in the restaurant context, the monitoring computing entity 100 can analyze the order completion times of orders completed by chef C593 during the work segment or work period in a sequential manner. And any gaps between the sequentially-ordered order completion times that meet or exceed the one or more configurable thresholds can be identified as segments of inactivity. For instance, chef C593 entered input that order 1634 was completed on 17:37:01 and completed order 1642 at 17:59:46. Thus, there is a gap in time 22 minutes and 42 seconds between completing order 1634 and completing order 1642. Any gaps between the sequentially-ordered order completion times that meet or exceed the one or more configurable thresholds can be identified as segments of inactivity. The monitoring computing entity 100 can perform such analyses for all activities during the work period and/or work segment.

In one embodiment, if the monitoring computing entity 100 identifies segments of inactivity meeting or exceeding one or more thresholds, the monitoring computing entity 100 can tag or assign an alert identifier to the segments of inactivity meeting or exceeding one or more of the configurable thresholds. For instance, in one embodiment, the tags or assigned alert identifiers are metadata identifying particular segments of inactivity.

In another embodiment, if the monitoring computing entity 100 identifies segments of inactivity meeting or exceeding one or more thresholds, before tagging or assigning an alert to the segments, the monitoring computing entity 100 analyze the work data to determine whether there is any input associated with the segments of inactivity. For example, during this work period, package loader/unloader E8675309 took a lunch break from 14:09:46-14:40:23. Package loader/unloader E8675309 also input that he or she had a period of inactivity from 15:13:17-15:33:46 that corresponds to reason code 11. Similarly, chef C593 took three breaks: (1) Break 1 from 15:39:46-15:50:23; (2) Break 2 from 17:11:43-17:39:56; and (3) Break 3 from 21:42:46-22:07:35. Thus, the monitoring computing entity 100 analyze the work data to determine whether there is a complete or partial overlap, for example, between any segments of inactivity and input of breaks, lunches, and/or other reasons for inactivity, such as assisting a coworker or a mechanical malfunction of equipment. The monitoring computing entity 100 can also analyze the work data to determine whether there is input of breaks, lunches, and/or other reasons for inactivity proximately before or proximately after the inactivity segments. If the inactivity segment is justified for a break, for example, the monitoring computing entity 100 may tag or assign an alert accordingly. Similarly, if the inactivity segment is not justified, the monitoring computing entity 100 may tag or assign an alert. As will be recognized, a variety of other approaches and techniques can be used to adapt to various needs and circumstances.

In another embodiment, if the monitoring computing entity 100 identifies segments of inactivity meeting or exceeding one or more thresholds, before tagging or assigning an alert to the segments, the monitoring computing entity 100 can analyze the activity data to determine whether the inactivity segment was associated with worker movement, e.g., a worker moving from one end of a warehouse to another. This is provided that there is no inactivity reason or code associated with the inactivity segment. For example, during this work period, if package loader/unloader E8675309 loaded package 1Z123456789 into Trailer 8ZR13547GF at 11:20:35 and package 1Z999999999 into Trailer 8ZR33333GF at 11:27:47, the monitoring computing entity 100 may determine that the time gap between 11:20:35 and 11:27:47 corresponds to the worker walking, driving, or otherwise traveling from Trailer 8ZR13547GF to Trailer 8ZR33333GF. That is, the time is associated with a movement segment. In certain embodiments, in identifying movement segments, the monitoring computing entity 100 can consider the relative locations of the trailers, facilities, equipment, and/or the like.

In one embodiment, if the monitoring computing entity 100 identifies segments of inactivity meeting or exceeding one or more thresholds, the monitoring computing entity 100 can tag or assign an alert identifier to the segments of inactivity meeting or exceeding one or more of the configurable thresholds—regardless of whether the monitoring computing entities identifies a valid reason in the work data for the inactivity segment. In another embodiment, if the monitoring computing entity 100 identifies segments of inactivity meeting or exceeding one or more thresholds, the monitoring computing entity 100 can tag or assign an alert identifier to the segments of inactivity meeting or exceeding one or more of the configurable thresholds—only if the monitoring computing entity does not identify a valid reason in the work data for the inactivity segment. In another embodiment, if the monitoring computing entity 100 identifies segments of inactivity meeting or exceeding one or more thresholds, the monitoring computing entity 100 can tag or assign an alert identifier to the segments of inactivity and further indicate the corresponding inactivity reason or code. The monitoring computing entity 100 can also tag or assign an alert identifier to the segments of movement and/or a variety of other segments that are identifiable/determinable based at least in part on the activity data and/or work data.

In one embodiment, the monitoring computing entity 100 can generate an alert indicating to a user that the monitoring computing entity 100 has analyzed activity data or work data that meets or exceeds one or more of the configurable thresholds. For example, in one embodiment, the monitoring computing entity 100 can send an email, text message, pop-up alert, and/or the like with such an indication. In yet another embodiment, the monitoring computing entity 100 may generate an alert via a user interface (e.g., for display via a user computing entity 105) indicating the identified inactivity segments.

The monitoring computing entity can also determine the number of activities for a work period, work segment, and/or the like. This may include determining the number of packages loaded or unloaded during a work period or work segment by an individual worker, by a team of workers, at a particular cargo bay, or within a facility. In another example, this may include determining the number of entrées, sides, and/or salads prepared by an individual chef, by a team of chefs, or by a restaurant for a work period or work segment. Further, the monitoring computing entity 100 can compare workers, worker groups, facilities, benchmarks, and/or the like that may be of interest to users (e.g., a supervisor reviewing the performance of loaders/unloaders or a restaurant owner or manager reviewing the productivity of chefs or servers).

### 4. Display of Segmented Data (Work Data and Activity Data)

In one embodiment, the monitoring computing entity 100 can cause display of various segments identified/determined from the work data and/or activity data. For example, this may allow users to view all inactivity segments meeting or exceeding one or more configurable thresholds. According to one embodiment, such segments may be displayed in an interface via a user computing entity 105, similar to those illustrated in FIGS. 11 and 12.

Such an interface may provide information such as the date and time each segment occurred, the start time of each segment, the duration of each segment, the end time of each segment, data corresponding the segment (e.g., inactivity reasons or codes), and/or the like. In a further embodiment, the interface may be configured such that the user may select a particular segment (e.g., with a computer mouse, other input, such as hovering over) and view the activity data or work data collected proximately before, proximately after, or during the particular segment. In this embodiment, the user may be provided with the option of browsing the work data and activity data proximate to or during the specific segment to determine the source of any potential inefficiencies and/or the like.

As shown in FIG. 11, the interface causes display of activity and work data corresponding to two loaders/unloaders and two locations. The interface also causes display of the start-of-work segments, movement segments, work segments, inactivity segments (the white blocked sections underneath the work segments), break segments, and end-of-work segments. FIG. 11 shows the number of packages handled in each work segment, the average number of packages handled per hour in each work segment, and a histogram of packages loaded every X minutes, such as the number of packages loaded every five minutes.

As shown in FIG. 12, the interface causes display of activity and work data corresponding to two chefs. The interface also causes display of the start-of-work segments, explained segments (inactivity segments with a corresponding inactivity reason or code), work segments, inactivity segments (the white blocked sections underneath the work segments), break segments, and end-of-work segments. FIG. 12 shows the number of entrées completed in each work segment, the average number of entrées completed per hour in each work segment, and a histogram of the number entrées completed every X minutes, such as the number of entrées completed every 15 minutes.

As will be recognized, a variety of other approaches and techniques may be used to cause display of information to adapt to various needs and circumstances.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for monitoring recurring activities, the method comprising:
receiving activity data corresponding to a worker and a work period in which the worker performed one or more recurring activities; and
identifying one or more inactivity segments during the work period that meet a configurable threshold based at least in part on the activity data, the one or more inactivity segments representing a time period for which the worker did not perform recurring activities during the work period.

2. The method of claim 1 further comprising assigning an alert to the one or more inactivity segments.

3. The method of claim 1 further comprising:
receiving work data corresponding to the worker and the work period in which the worker performed one or more recurring activities;
determining whether the one or more inactivity segments identified based at least in part on the activity data correspond to inactivity reasons based at least in part on the work data.

4. The method of claim 1 further comprising determining the total number of recurring activities performed by the worker during the work period.

5. The method of claim 1 further comprising determining the average number of recurring activities performed by the worker during the work period.

6. The method of claim 1 further comprising comparing the average number of recurring activities performed by the worker during the work period to a benchmark.

7. The method of claim 1 further comprising causing display of the inactivity segments and at least a portion of the corresponding activity data.

8. The method of claim 1 further comprising:
identifying a start-of-work segment during the work period, the start-of-work segment representing a time period between when the worker started work for the work period and when the worker performed the first recurring activity during the work period; and
identifying an end-of-work segment during the work period, the end-of-work segment representing a time period between when the worker performed the last recurring activity during the work period and ended work for the work period.

9. The method of claim 1 further comprising:
identifying one or more movement segments during the work period based at least in part on where the worker performed the recurring activities during the work period.

10. An apparatus comprising at least one processor and at least one memory including computer program code, the at least one memory and the computer program code configured to, with the processor, cause the apparatus to at least:
receive activity data corresponding to a worker and a work period in which the worker performed one or more recurring activities; and
identify one or more inactivity segments during the work period that meet a configurable threshold based at least in part on the activity data, the one or more inactivity segments representing a time period for which the worker did not perform recurring activities during the work period.

11. The apparatus claim 10, wherein the memory and computer program code are further configured to, with the processor, cause the apparatus to assign an alert to the one or more inactivity segments.

12. The apparatus claim 10, wherein the memory and computer program code are further configured to, with the processor, cause the apparatus to:
receive work data corresponding to the worker and the work period in which the worker performed one or more recurring activities;
determine whether the one or more inactivity segments identified based at least in part on the activity data correspond to inactivity reasons based at least in part on the work data.

13. The apparatus claim 10, wherein the memory and computer program code are further configured to, with the processor, cause the apparatus to determine the total number of recurring activities performed by the worker during the work period.

14. The apparatus claim 10, wherein the memory and computer program code are further configured to, with the processor, cause the apparatus to determine the average number of recurring activities performed by the worker during the work period.

15. The apparatus claim 10, wherein the memory and computer program code are further configured to, with the processor, cause the apparatus to compare the average number of recurring activities performed by the worker during the work period to a benchmark.

16. The apparatus claim 10, wherein the memory and computer program code are further configured to, with the processor, cause the apparatus to cause display of the inactivity segments and at least a portion of the corresponding activity data.

17. The apparatus claim 10, wherein the memory and computer program code are further configured to, with the processor, cause the apparatus to:
identify a start-of-work segment during the work period, the start-of-work segment representing a time period between when the worker started work for the work period and when the worker performed the first recurring activity during the work period; and
identify an end-of-work segment during the work period, the end-of-work segment representing a time period between when the worker performed the last recurring activity during the work period and ended work for the work period.

18. The apparatus claim 10, wherein the memory and computer program code are further configured to, with the processor, cause the apparatus to identify one or more movement segments during the work period based at least in part on where the worker performed the recurring activities during the work period.

19. A computer program product for monitoring recurring activities, the computer program product comprising at least one non-transitory computer-readable storage medium having computer-readable program code portions stored therein, the computer-readable program code portions comprising:
an executable portion configured to receive activity data corresponding to a worker and a work period in which the worker performed one or more recurring activities; and
an executable portion configured to identify one or more inactivity segments during the work period that meet a configurable threshold based at least in part on the activity data, the one or more inactivity segments representing a time period for which the worker did not perform recurring activities during the work period.

20. The computer program product of claim 19 further comprising an executable portion configured to assign an alert to the one or more inactivity segments.

21. The computer program product of claim 19 further comprising:
an executable portion configured to receive work data corresponding to the worker and the work period in which the worker performed one or more recurring activities;
an executable portion configured to determine whether the one or more inactivity segments identified based at least in part on the activity data correspond to inactivity reasons based at least in part on the work data.

22. The computer program product of claim 19 further comprising an executable portion configured to determine the total number of recurring activities performed by the worker during the work period.

23. The computer program product of claim 19 further comprising an executable portion configured to determine the average number of recurring activities performed by the worker during the work period.

24. The computer program product of claim 19 further comprising an executable portion configured to compare the average number of recurring activities performed by the worker during the work period to a benchmark.

25. The computer program product of claim 19 further comprising an executable portion configured to cause display of the inactivity segments and at least a portion of the corresponding activity data.

26. The computer program product of claim 19 further comprising:
an executable portion configured to identify a start-of-work segment during the work period, the start-of-work segment representing a time period between when the worker started work for the work period and when the worker performed the first recurring activity during the work period; and
an executable portion configured to identify an end-of-work segment during the work period, the end-of-work segment representing a time period between when the worker performed the last recurring activity during the work period and ended work for the work period.

27. The apparatus claim 10, wherein the memory and computer program code are further configured to, with the processor, cause the apparatus to identify one or more movement segments during the work period based at least in part on where the worker performed the recurring activities during the work period.
